(19) United States
(12) Patent Application Publication
(10) Pub. No.: US 2024/0128495 A1
(43) Pub. Date: Apr. 18, 2024

(54) SOLID ELECTROLYTE AND METHOD FOR PRODUCING SAME

(71) Applicant: Mitsui Mining & Smelting Co., Ltd., Tokyo (JP)

(72) Inventors: Katsuya ICHIKI, Ageo (JP); Tsukasa TAKAHASHI, Ageo (JP)

(21) Appl. No.: 18/277,512

(22) PCT Filed: Mar. 4, 2022
(86) PCT No.: PCT/JP2022/009502

§ 371 Date: Aug. 16, 2023

(30) Foreign Application Priority Data
Mar. 11, 2021 (JP) 2021-039746

(51) Int. Cl. H01M 10/0562

(52) U.S. Cl. CPC H01M 10/0562; H01M 2300/008

(57) ABSTRACT

A solid electrolyte contains: a lithium (Li) element; a phosphorus (P) element; a sulfur (S) element; and an X element, where X represents at least one halogen element. The solid electrolyte has a peak P₁ and a peak P₂ when, in an X-ray diffraction pattern obtained by measuring the solid electrolyte with an X-ray diffractometer (XRD) using CuKα1 rays and CuKα2 rays, a diffraction pattern in at least any one of a range of 2θ=25.6±0.8°, a range of 2θ=30.2±0.8°, and a range of 2θ=31.6±0.8° is subjected to peak separation. The peak P₁ and the peak P₂ are derived from different phases.

### CROSS REFERENCE TO RELATED APPLICATIONS

This application is a U.S. National Phase Application under 35 U.S.C. 371 of International Application No. PCT/JP2022/009502, filed on Mar. 4, 2022, which claims priority to Japanese Patent Application No. 2021-039746, filed on Mar. 11, 2021. The entire disclosures of the above applications are expressly incorporated by reference herein.

### BACKGROUND

### Technical Field

The present invention relates to a solid electrolyte and a method for producing the same.

### Related Art

In recent years, a solid electrolyte that can replace a liquid electrolyte used in many liquid-based batteries has attracted attention. A solid-state battery that contains a solid electrolyte is expected to be brought into practical use as a battery that is not only safer than a liquid-based battery that contains a flammable organic solvent, but also has high energy density.

The technique disclosed in US 2016/156064A1 is known as a conventional technique for a solid electrolyte, for example. In recent years, studies are actively being conducted to obtain a solid electrolyte that provides even better performance. Various investigations are being performed on, for example, a solid electrolyte with high ion conductivity.

It is an object of the present invention to provide a solid electrolyte that has higher ion conductivity.

### SUMMARY

The present invention provides a solid electrolyte containing: a lithium (Li) element; a phosphorus (P) element; a sulfur (S) element; and an X element, where X represents at least one halogen element, wherein the solid electrolyte has a peak P₁ and a peak P₂ when, in an X-ray diffraction pattern obtained by measuring the solid electrolyte with an X-ray diffractometer (XRD) using CuKα1 rays and CuKα2 rays, a diffraction pattern in at least any one of a range of 2θ=25.6±0.8°, a range of 2θ=30.2±0.8°, and a range of 2θ=31.6±0.8° is subjected to peak separation, and the peak P₁ and the peak P₂ are derived from different phases.

The present invention also provides a method for producing a solid electrolyte including the steps of: obtaining a raw material composition by mixing a lithium (Li) element source, a phosphorus (P) element source, a sulfur (S) element source, and a halogen (X) element source; and calcining the raw material composition at a temperature of higher than 500° C. and lower than 700° C.

### BRIEF DESCRIPTION OF THE DRAWINGS

FIG. 1A is a diagram showing an example of an X-ray diffraction pattern obtained by measuring a conventional solid electrolyte of a single phase using an X-ray diffractometer, and FIG. 1B is a diagram obtained by separating the X-ray diffraction pattern shown in FIG. 1A into two peaks.

FIG. 2A is a diagram showing an example of an X-ray diffraction pattern obtained by measuring a solid electrolyte according to the present invention using an X-ray diffractometer, and FIG. 2B is a diagram obtained by separating the X-ray diffraction pattern shown in FIG. 2A into two peaks.

FIG. 3 is a diagram showing X-ray diffraction patterns of solid electrolytes obtained in Example 2 and Comparative Example 2.

FIG. 4 is a diagram showing X-ray diffraction patterns of solid electrolytes obtained in Example 3 and Comparative Example 3.

### DETAILED DESCRIPTION

Hereinafter, the present invention will be described based on a preferred embodiment thereof. A solid electrolyte according to the present invention contains at least a lithium (Li) element, a phosphorus (P) element, a sulfur (S) element, and a halogen (X) element.

The X element contained in the solid electrolyte of the present invention is at least one halogen element, and more specifically, at least one element selected from a chlorine (Cl) element, a bromine (Br) element, and an iodine (I) element. The X element may be any one of or a combination of two or more of the elements listed above.

From the viewpoint of increasing the lithium ion conductivity of the solid electrolyte of the present invention, the solid electrolyte preferably contains at least a Cl element as the X element. In particular, it is preferable that the solid electrolyte contains only a Cl element as the X element because the solid electrolyte that has two or more different phases, which will be described below, is likely to be obtained.

The solid electrolyte of the present invention is characterized by a feature in that the solid electrolyte has two or more different phases. The two or more different phases are crystalline phases. As a result of studies conducted by the inventors of the present application, it was found that, as a result of having two or more different phases, the solid electrolyte of the present invention can exhibit even better ion conductivity than conventional solid electrolytes. The reason is not completely clear, but the inventors of the present application consider the reason as follows. Of course, the scope of the present invention is not limited to the theory described below. It is considered that the two or more different phases are crystalline phases, and they are present in one crystal grain. Each of the plurality of crystal phases present in one crystal grain contains a Li element, a P element, an S element, and an X element, but the compositions are different from each other. As a result of at least one of the plurality of crystal phases present in one crystal grain being a high-ion conductive phase, the solid electrolyte has high ion conductivity as a whole. Alternatively, it is considered that, as a result of interface resistance between the plurality of crystal phases present in one crystal grain being small, the solid electrolyte has high ion conductivity as a whole.

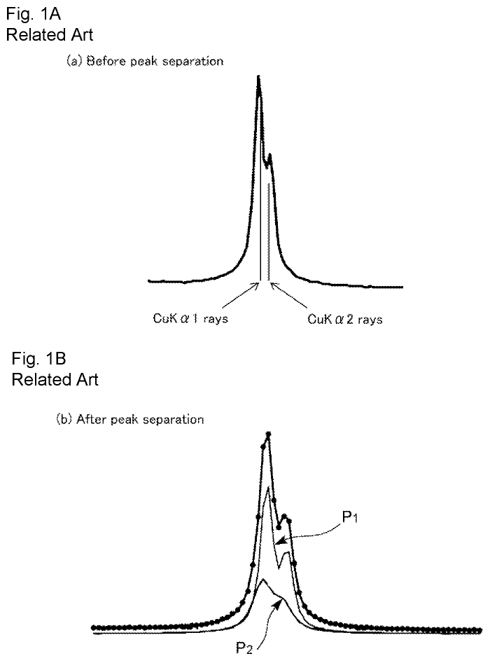

Whether or not the solid electrolyte of the present invention has two or more different phases can be confirmed based on an X-ray diffraction pattern obtained by measuring the solid electrolyte using an X-ray diffractometer (XRD). To be specific, whether or not the solid electrolyte of the present invention has two or more different phases can be confirmed based on an X-ray diffraction pattern obtained by using X rays of two different wavelengths as ray sources for XRD. As X-ray sources that provide X rays of two different wavelengths, it is convenient to use CuKα1 rays and CuKα2 rays. CuKα1 rays have a wavelength of 0.1540562 nm, and CuKα2 have a wavelength of 0.1544390 nm. The intensity ratio of CuKα1 rays and CuKα2 rays is theoretically about 2:1. Accordingly, in the case where a solid electrolyte of a single phase is subjected to XRD measurement, when the solid electrolyte is simultaneously irradiated with CuKα1 rays and CuKα2 rays, an X-ray diffraction pattern shown in FIG. 1A is obtained. As shown in the X-ray diffraction pattern, a diffraction line derived from CuKα1 rays and a diffraction line derived from CuKα2 rays are superimposed at an intensity ratio of 2:1.

When the diffraction pattern in which the diffraction lines are superimposed as shown in FIG. 1A is subjected to mathematical peak separation based on a minimum square root method, the diffraction pattern is separated into peaks P₁ and P₂ whose peak tops are at the same position as shown in FIG. 1B. The term “peak” used in the present invention refers to where a diffraction line derived from CuKα1 rays and a diffraction line derived from CuKα2 rays are superimposed at an intensity ratio of 2:1.

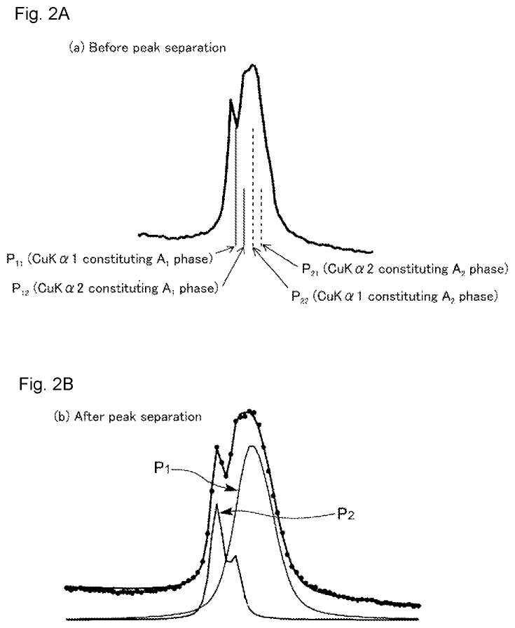

As will be described in Examples given later, diffraction intensity data actually acquired through XRD are discrete (for example, the step width 2θ indicated by the horizontal axis shown in FIG. 2B is 0.02°). Accordingly, the peak tops of two peaks P₁ and P₂ obtained through the mathematical peak separation based on the minimum square root method may not be at strictly the same position, and the positions of the peak tops may be slightly different. That is, the positions of the peak tops of two peaks obtained through separation are theoretically the same, but the positions of the peak tops of two peaks obtained through mathematical peak separation may be slightly different. Accordingly, in the description of the present application, when the absolute value (Δ2θ) of the difference between the positions of the peak tops of two peaks P₁ and P₂ obtained through separation is 0.04° or less, the positions of the peak tops of the two peaks are deemed as the same.

On the other hand, when the solid electrolyte of the present invention is simultaneously irradiated with CuKα1 rays and CuKα2 rays, a diffraction pattern as described below is obtained. For the sake of convenience, the following description will be given based on an example in which the solid electrolyte of the present invention has two different crystal phases.

It is assumed here that the two different crystal phases are a phase A₁ and a phase A₂. When the solid electrolyte of the present invention that has a phase A₁ and a phase A₂ is simultaneously irradiated with CuKα1 rays and CuKα2 rays, as shown in FIG. 2A, with respect to the phase A₁, a diffraction line P₁₁ derived from CuKα1 rays and a diffraction line P₁₂ derived from CuKα2 rays are observed at an intensity ratio of 2:1, and with respect to the phase A₂ phase, a diffraction line P₂₁ derived from CuKα1 rays and a diffraction line P₂₂ derived from CuKα2 rays are observed at an intensity ratio of 2:1. That is, a diffraction pattern in which four diffraction lines P₁₁, P₁₂, P₂₁, and P₂₂ are superimposed is obtained.

When the diffraction pattern in which the diffraction lines are superimposed as shown in FIG. 2A is subjected to mathematical peak separation based on a minimum square root method to separate the diffraction pattern into two peaks, as shown in FIG. 2B, two peaks P₁ and P₂ whose peak tops are at different positions are observed. In the description of the present application, the peak P₁ is a peak at which the diffraction lines P₁₁ and P₁₂ are superimposed, and the peak P₂ is a peak at which the diffraction lines P₂₁ and P₂₂ are superimposed. In the case where two peak tops are observed such as P₁ shown in FIG. 2B, one of the two peak tops that has higher intensity is defined as the peak top.

As described above, when a diffraction pattern obtained by simultaneously irradiating a solid electrolyte with CuKα1 rays and CuKα2 rays is separated into two peaks, and the two peaks obtained through the separation have peak tops at different positions, it is possible to determine that the solid electrolyte has two or more different crystal phases.

In the solid electrolyte of the present invention, from the viewpoint of further increasing the ion conductivity of the solid electrolyte, it is preferable that the solid electrolyte has a peak P₁ and a peak P₂ when, in an X-ray diffraction pattern obtained by measuring the solid electrolyte with XRD using CuKα1 rays and CuKα2 rays, a diffraction pattern in at least any one of a range of 2θ=25.6±0.8° (hereinafter, this range will also be referred to as “first range”), a range of 2θ=30.2±0.8° (hereinafter, this range will also be referred to as “second range”), and a range of 2θ=31.6±0.8° (hereinafter, this range will also be referred to as “third range”) is subjected to peak separation, and the peak P₁ and the peak P₂ are derived from different phases. In particular, from the viewpoint of further increasing the ion conductivity of the solid electrolyte, it is preferable that, when diffraction patterns in at least two angle ranges out of the first to third ranges are subjected to peak separation, the solid electrolyte has a peak P₁ and a peak P₂ that are derived from different phases. It is more preferable that, when diffraction patterns in all of the first to third ranges are subjected to peak separation, the solid electrolyte has a peak P₁ and a peak P₂ that are derived from different phases.

In the solid electrolyte of the present invention, diffraction patterns may be observed at angles other than those of the first to third ranges described above. When compared in terms of intensity, the diffraction patterns observed in the first to third ranges exhibit very high intensity. For this reason, peak separation is performed on the diffraction patterns observed in the first to third ranges.

As described above, the solid electrolyte of the present invention has two or more different phases. The two or more different phases have different compositions, and thus have different lattice constants. As a result, as described above, when an XRD diffraction pattern is separated into a plurality of peaks, a plurality of peaks whose peak tops are at different positions are observed. It is preferable that, where two or more peaks derived from different phases are sequentially represented by P₁ and P₂ in this order from the low angle side, an angle difference Δ2θ (=2θ₂−2θ₁) between an angle 2θ₁ at the peak top position of P₁ and an angle 2θ₂ at the peak top position of P₂ is 0.04° or more, because the ion conductivity of the solid electrolyte is further increased. From the viewpoint of further making this advantage more prominent, the angle difference Δ2θ is preferably 0.10° or more, and more preferably 0.11° or more. On the other hand, the upper limit value of the angle difference Δ2θ is preferably 1.6° or less.

When each of the diffraction patterns obtained in the first to third ranges is separated into two peaks P₁ and P₂, there may be a case where the intensity of the peak P₁ is higher than that of the peak P₂, or vice versa. From the viewpoint of further increasing the lithium ion conductivity of the solid electrolyte, I₁/I₂ that is the ratio of intensity I₁ of the peak P₁ and intensity I₂ of the peak P₂ is preferably 0.8 or less, and more preferably 0.4 or less. The intensity I₁ of the peak P₁ and the intensity I₂ of the peak P₂ used in the description of the present application are parameters obtained when diffraction pattern peak separation based on a minimum square root method is performed. In the case where a plurality of peaks are observed, it is preferable that one of the plurality of peaks that has the highest peak intensity satisfies the above-described conditions.

When peak separation processing is performed on a diffraction pattern obtained by subj ecting a mixture of a solid electrolyte that has a first phase of a single composition and a solid electrolyte that has a second phase of a single composition to XRD measurement, a plurality of peaks whose peak tops are at different positions are observed. However, this mixture does not necessarily have high lithium ion conductivity. The reason is that, when this mixture is used, it is not possible to reduce the interface resistance between two phases. That is, the solid electrolyte of the present invention is composed of a single substance (or in other words, the solid electrolyte is not composed of a mixture), and has two or more different crystal phases. Of course, it is also possible to use a configuration in which the solid electrolyte of the present invention is mixed with another solid electrolyte and used.

As described above, the solid electrolyte of the present invention contains a Li element, a P element, an S element, and an X element. As an example of the solid electrolyte, it is possible to use Li₂S—P₂S₅—LiX or the like, where X represents at least one halogen element. However, the solid electrolyte of the present invention is not limited thereto.

In particular, from the viewpoint of increasing the lithium ion conductivity of the solid electrolyte, it is preferable that the solid electrolyte that contains the elements described above contains a compound represented by a composition formula: LiₐPS_{b}X_{c}, where X represents at least one halogen element, a is a number of 3.0 or more and 6.0 or less, b is a number of 3.5 or more and 4.8 or less, and c is a number of 0.1 or more and 3.0 or less.

In the composition formula given above, a that represents the molar ratio of the Li element is, for example, preferably a number of 3.0 or more and 6.0 or less, more preferably 3.2 or more and 5.8 or less, and even more preferably 3.4 or more and 5.4 or less. Note that a may be a number less than 5.4.

In the composition formula given above, b that represents the molar ratio of the S element is, for example, preferably a number of 3.5 or more and 4.8 or less, more preferably 3.8 or more and 4.6 or less, and even more preferably 4.0 or more and 4.4 or less. Note that b may be a number less than 4.4.

In the composition formula given above, c is, for example, preferably a number of 0.1 or more and 3.0 or less, more preferably 0.2 or more and 2.5 or less, and even more preferably 0.4 or more and 2.0 or less. The compound represented by the composition formula in which a, b, and c are within the ranges described above has sufficiently high lithium ion conductivity.

In particular, from the viewpoint of further increasing the lithium ion conductivity, in the solid electrolyte of the present invention, it is preferable that the value of X/P that is the molar ratio of the X element to the P element is greater than 1.0. From this viewpoint, the value of X/P is preferably 1.2 or more, and more preferably 1.6 or more. From the viewpoint that it is preferable to stably maintain the argyrodite structure, the value of X/P is preferably 2.0 or less.

In the present invention, the compound prepared by adjusting the amounts of materials to satisfy the composition formula LiₐPS_{b}X_{c} may contain an element other than the Li element, the P element, the S element, and the X element. For example, the Li element may be partially replaced with another alkali metal element, the P element may be partially replaced with another pnictogen element, or the S element may be partially replaced with another chalcogen element.

From the viewpoint of increasing the lithium ion conductivity of the solid electrolyte, in particular, the solid electrolyte of the present invention preferably has a crystal phase of an argyrodite-type crystal structure. The term “argyrodite-type crystal structure” used herein refers to a crystal structure of a group of compounds derived from a mineral represented by the following chemical formula: Ag₈GeS₆. Whether or not the solid electrolyte of the present invention has a crystal phase of an argyrodite-type crystal structure can be confirmed by performing XRD measurement or the like. For example, in a diffraction pattern obtained through XRD measurement using CuKα1 rays, the crystal phase of an argyrodite-type crystal structure exhibits characteristic diffraction peaks at 2θ=15.3°±1.0°, 17.7°±1.0°, 25.6°±1.0°, 30.2°±1.0°, 31.6°±1.0°, and 44.7°±1.0°. Furthermore, the crystal phase of an argyrodite-type crystal structure may also exhibit, in addition to the diffraction peaks described above, characteristic diffraction peaks at, for example, 2θ=47.2°±1.0°, 51.7°±1.0°, 58.3°±1.0°, 60.7°±1.0°, 61.5°±1.0°, 70.4°±1.0°, and 72.6°±1.0°, depending on the types of elements that constitute the solid electrolyte. For identification of the diffraction peaks derived from the argyrodite-type crystal structure, it is possible to use, PDF data No. 00-034-0688, for example.

The solid electrolyte of the present invention has lithium ion conductivity when in a solid state. The solid electrolyte of the present invention preferably has lithium ion conductivity at, for example, room temperature, or in other words, at 25° C. of 0.5 mS/cm or more, more preferably 1.0 mS/cm or more, even more preferably 1.5 mS/cm or more, and even much more preferably 4.0 mS/cm or more. The lithium ion conductivity can be measured using a method described in Examples given later.

The solid electrolyte of the present invention can be produced preferably using a method described below. A Li element source compound, a P element source compound, an S element source compound, and an X element source compound are used as raw materials. As the Li element source compound, for example, lithium sulfide (Li₂S) can be used. As the P element source compound, for example, phosphorus pentasulfide (P₂S₅) can be used. As the S element source compound, when the Li element source compound and/or the P element source compound contain a sulfide, the sulfide can be used as the S element source compound. As the X element source compound, a compound B (LiX) can be used. These raw materials are mixed such that the Li element, the P element, the S element, and the X element satisfy a predetermined molar ratio. Then, a raw material composition obtained by mixing these raw materials is calcined in an inert atmosphere or a hydrogen sulfide gas-containing atmosphere.

Particularly when the calcination temperature is within a later-described temperature range, by using an inert gas atmosphere such as, for example, a nitrogen atmosphere or an argon atmosphere as the calcination atmosphere, it is possible to successfully obtain a solid electrolyte in which a plurality of crystal phases are present in one crystal grain.

In particular, in the production method of the present invention, by adjusting the calcination conditions as described above, it is possible to obtain a solid electrolyte in which a plurality of crystal phases are present in one crystal grain. Specifically, as a result of studies conducted by the inventors of the present application, it was found that a plurality of crystal phases can be produced by performing calcination at a temperature higher than a conventionally used calcination temperature, for example, a temperature used in US 2016/156064A1. From this viewpoint, it is preferable to set the calcination temperature to be higher than 500° C. On the other hand, if the calcination temperature is set to an excessively high temperature, a heterophase that impairs the lithium ion conductivity may be produced. For this reason, the calcination temperature is preferably set to be lower than 700° C. From the viewpoint described above, the calcination temperature is more preferably set to 540° C. or higher and 660° C. or lower and even more preferably 580° C. or higher and 620° C. or less.

The calcination time is preferably set to 1 hour or more and 7 hours or less, more preferably 2 hours or more and 6 hours or less, and even more preferably 3 hours or more and 5 hours or less as long as the calcination temperature is within the above-described range.

A calcined product obtained in the manner described above is subjected to a predetermined milling step. When milling the calcined product, the calcined product may be milled by performing dry milling, wet milling, or a combination of dry milling and wet milling.

When the calcined product is milled using dry milling, for example, a jet mill, a ball mill, a rod mill, a vibration ball mill, a planetary mill, a disc mill, or the like can be used. On the other hand, when the calcined product is milled using wet milling, various types of media mills can be used. Examples of the media mills that can be used include a ball mill, a bead mill, a paint shaker, a homogenizer, and the like.

When the calcined product is milled using wet milling, a milled product is separated into a solid electrolyte powder and a solvent after the wet milling. To obtain a solid electrolyte powder and a solvent separated from the milled product, for example, it is preferable to subject a slurry containing a solid electrolyte powder and an organic solvent to solid-liquid separation processing by performing an operation such as natural filtration, centrifugation, pressure filtration, vacuum filtration, or the like. Alternatively, the slurry may be subjected to hot-air drying or vacuum drying, without performing the operation.

The solid electrolyte obtained using the method described above can be used as a material for constituting a solid electrolyte layer, a positive electrode layer, or a negative electrode layer. Specifically, the solid electrolyte of the present invention can be used in a battery that includes a positive electrode layer, a negative electrode layer, and a solid electrolyte layer provided between the positive electrode layer and the negative electrode layer. That is, the solid electrolyte of the present invention can be used in a so-called solid-state battery. More specifically, the solid electrolyte of the present invention can be used in a lithium solid-state battery. The lithium solid-state battery may be a primary battery or a secondary battery. There is no particular limitation on the battery shape. For example, a laminate shape, a cylindrical shape, a prismatic shape, or the like can be used. The term “solid-state battery” used herein encompasses not only a solid-state battery that does not contain a liquid substance or a gel substance as the electrolyte, but also a solid-state battery that contains, for example, 50 mass % or less, 30 mass % or less, or 10 mass % or less of a liquid substance or a gel substance as the electrolyte.

In the case where the solid electrolyte of the present invention is contained in a solid electrolyte layer, the solid electrolyte layer can be produced using, for example, any of the following methods: a method in which a slurry that contains the solid electrolyte, a binder, and a solvent is dropped onto a substrate, and the slurry is spread using a doctor blade or the like; a method in which a substrate and the slurry are brought into contact with each other, and then cut using an air knife; a method in which a coating film is formed using a screen printing method or the like, and then heated and dried to remove the solvent; and the like. Alternatively, the solid electrolyte layer can also be produced by pressing the solid electrolyte of the present invention in the form of powder into a powder compact, and subjecting the powder compact to appropriate processing. From the viewpoint of balance between prevention of a short-circuit and volume capacity density, typically, the thickness of the solid electrolyte layer is preferably 5 μm or more and 300 μm or less, and more preferably 10 μm or more and 100 μm or less.

The solid electrolyte of the present invention is used together with an active material to constitute an electrode material mixture. The proportion of the solid electrolyte in the electrode material mixture is typically 10 mass % or more and 50 mass % or less. The electrode material mixture may also contain other materials such as a conductive aid and a binder as needed. An electrode layer such as a positive electrode layer and/or a negative electrode layer can be produced by mixing an electrode material mixture and a solvent to prepare a paste, applying the paste onto a current collector such as an aluminum foil, and drying the paste.

As a positive electrode material for constituting the positive electrode layer, any positive electrode material used as the positive electrode active material in a lithium ion battery can be used as appropriate. For example, a lithium-containing positive electrode active material, specifically, a spinel-type lithium transition metal oxide, a lithium metal oxide that has a layered structure, and the like can be used. By using a high-voltage type positive electrode material as the positive electrode material, the energy density can be improved. The positive electrode material may contain, in addition to the positive electrode active material, a conductive material or another material.

As a negative electrode material for constituting the negative electrode layer, any negative electrode material used as the negative electrode active material in a lithium ion battery can be used as appropriate. The solid electrolyte of the present invention is electrochemically stable. For this reason, a lithium metal or a carbon-based material, which is a material that performs charging and discharging at a low potential (about 0.1 V versus Li⁺/Li) corresponding to the potential of the lithium metal, such as graphite, artificial graphite, natural graphite, or non-graphitizable carbon (hard carbon) can be used as the negative electrode material. By using any of the materials listed above as the negative electrode material, the energy density of the solid-state battery can be improved remarkably. It is also possible to use, as the active material, silicon or tin that is considered to be a promising high capacity material. In a battery in which an ordinary electrolyte solution is used, the electrolyte solution reacts with the active material during charging and discharging, and corrosion occurs on the active material surface, causing remarkable deterioration in the battery characteristics. In contrast, when the solid electrolyte of the present invention is used instead of the electrolyte solution, and silicon or tin is used as the negative electrode active material, a corrosion reaction as described above does not occur, and thus the durability of the battery can be improved. The negative electrode material may also contain, in addition to the negative electrode active material, a conductive material or another material.

### EXAMPLES

Hereinafter, the present invention will be described in further detail based on examples. However, the scope of the present invention is not limited to the examples given below. Unless otherwise stated, the percent sign “%” used herein means “mass %”.

### Example 1

A Li₂S powder, a P₂S₅ powder, and a LiCl powder were weighed to satisfy the composition shown in Table 1 given below, such that the total amount was 5 g. These powders were milled and mixed using a wet ball mill with heptane to obtain a mixed composition. The mixed composition was calcined to obtain a calcined product. The calcination was performed using a tubular electric furnace. During the calcination, a 100% pure nitrogen gas was passed through the electric furnace. The calcination temperature was set to 600° C., and the calcination was performed for 4 hours.

The obtained calcined product was disintegrated using a mortar and a pestle. Then, the disintegrated product was milled using a wet ball mill with heptane.

The milled calcined product was dried through vacuum drying to remove heptane. The dried calcined product was classified using a sieve with a mesh size of 1 mm. In this way, an intended solid electrolyte powder was obtained. It was confirmed that the obtained solid electrolyte had an argyrodite-type crystal structure.

### Examples 2 and 3, and Comparative Examples 1 to 3

In each of Examples 2 and 3 and Comparative Examples 1 to 3, a solid electrolyte powder was obtained in the same manner as in Example 1, except that the raw material powders were mixed to satisfy the composition shown in Table 1, and the calcination conditions shown in Table 1 were used. It was confirmed that the obtained solid electrolyte had an argyrodite-type crystal structure.

### Evaluation

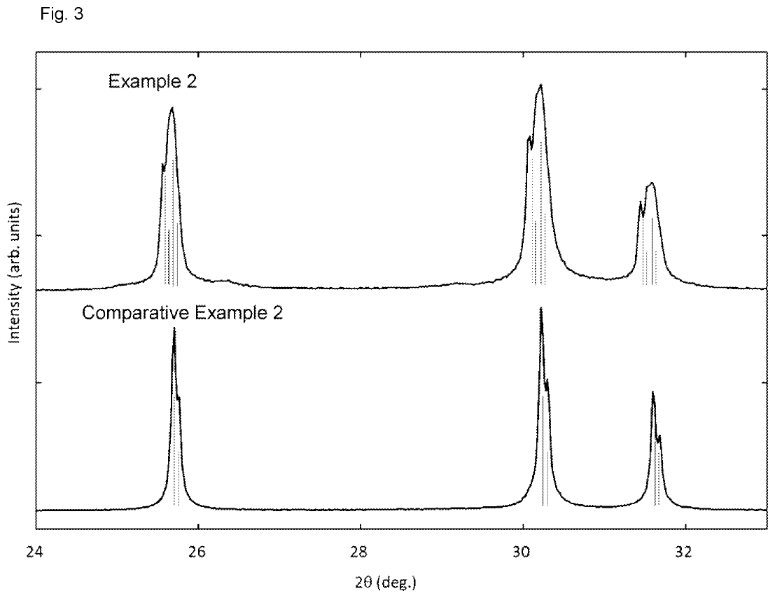

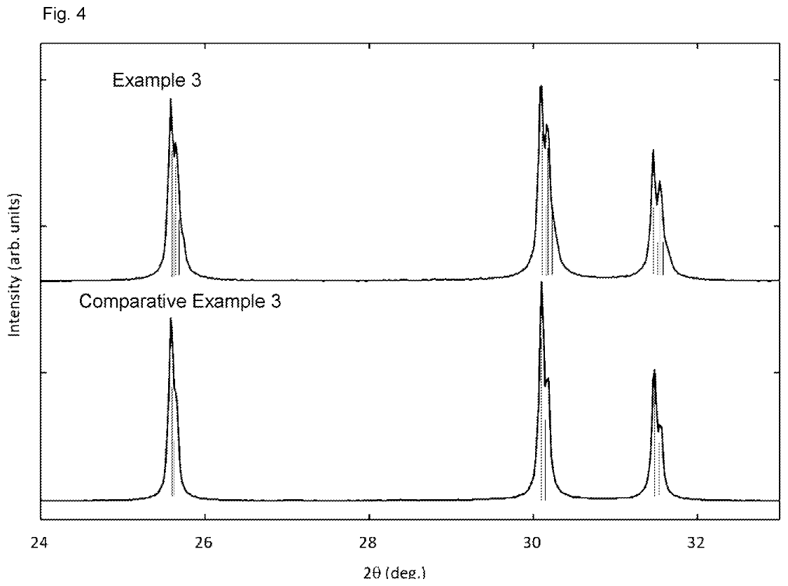

The solid electrolytes obtained in Examples and Comparative Examples were subjected to XRD measurement performed under the following conditions. Also, a diffraction pattern of each of the first to third ranges was subjected to an operation of separating the diffraction pattern into two peaks performed in the manner described below. XRD patterns of the solid electrolytes obtained in Examples 2 and 3, and Comparative Examples 2 and 3 are shown in FIGS. 3 and 4. Also, lithium ion conductivity was measured for each of the solid electrolytes obtained in Examples and Comparative Examples in the manner described below. The results are shown in Table 1 given below.

### XRD Measurement

Each solid electrolyte was subjected to measurement performed without exposing the solid electrolyte to ambient air using a powder X-ray diffractometer SmartLab SE available from Rigaku Corporation. The measurement conditions were as follows.
X-ray tube voltage: 40 kV
X-ray tube current: 50 mA
X rays: CuKα rays (including CuKα1 rays and CuKα2 rays at an intensity ratio of 2:1)
Optical system: Focused beam method
Detector: One-dimensional detector
Measurement range: 2θ=10 to 120°
Step width: 0.02°
Scan speed: 1°/min

### Peak Separation

In an obtained XRD pattern (represented by I_{XRD}(2θ)), a diffraction pattern in each of the first to third ranges was separated into two peaks P₁ and P₂ and BG representing the background of the diffraction pattern. Specifically, P₁, P₂, and BG were derived to satisfy the following equation:

I_{XRD}(2θ)=P₁+P₂+BG.

The peak separation was performed by performing curve fitting based on a minimum square root method using the Solver function of software Microsoft Excel for Office 365. Here, the peaks P₁ and P₂ were expressed by the following equations as a function of 2θ.

$${P}_{1} ( 2 θ ) = {I}_{1} {P}_{11} ( 2 θ ) + \frac{{I}_{1}}{2} {P}_{12} ( 2 θ ) \qquad [ Math . 1 ]$$

$${P}_{2} ( 2 θ ) = {I}_{2} {P}_{21} ( 2 θ ) + \frac{{I}_{2}}{2} {P}_{22} ( 2 θ )$$

Also, BG was expressed by a linear function connecting two data points at both ends of each of the target ranges of the first to third ranges with a straight line.

Here, I₁ and I₂ represent a positive constant indicating the intensity of peak P₁ and a positive constant indicating the intensity of P₂, respectively. P₁₁ and P₁₂ represent a diffraction line derived from CuKα1 rays constituting the peak P₁ and a diffraction line derived from CuKα2 rays constituting the peak P₁, respectively. Likewise, P₂₁ and P₂₂ represent a diffraction line derived from CuKα1 rays constituting the peak P₂ and a diffraction line derived from CuKα2 rays constituting the peak P₂, respectively. When performing the curve fitting, the diffraction lines P₁₁ and P₁₂ and the diffraction lines P₂₁ and P₂₂ were expressed as follows using a pseudo Voigt function that is a weighted sum of Lorentzian and Gaussian functions that have an equal half-width.

$${P}_{11} ( 2 θ ) = {η}_{11} \frac{2}{π {w}_{11}} {\{ 1 + 4 {( \frac{2 θ - 2 {θ}_{11}}{{w}_{11}} )}^{2} \}}^{- 1} + ( 1 - {η}_{11} ) \frac{2}{{w}_{11}} {( \frac{ln 2}{π} )}^{1 / 2} exp \{ - 4 ln 2 {( \frac{2 θ - 2 {θ}_{11}}{{w}_{11}} )}^{2} \} \qquad [ Math . 2 ]$$

$${P}_{12} ( 2 θ ) = {η}_{12} \frac{2}{π {w}_{12}} {\{ 1 + 4 {( \frac{2 θ - 2 {θ}_{12}}{{w}_{11}} )}^{2} \}}^{- 1} + ( 1 - {η}_{12} ) \frac{2}{{w}_{12}} {( \frac{ln 2}{π} )}^{1 / 2} exp \{ - 4 ln 2 {( \frac{2 θ - 2 {θ}_{12}}{{w}_{12}} )}^{2} \}$$

$${P}_{21} ( 2 θ ) = {η}_{31} \frac{2}{π {w}_{21}} {\{ 1 + 4 {( \frac{2 θ - 2 {θ}_{21}}{{w}_{21}} )}^{2} \}}^{- 1} + ( 1 - {η}_{21} ) \frac{2}{{w}_{21}} {( \frac{ln 2}{π} )}^{1 / 2} exp \{ - 4 ln 2 {( \frac{2 θ - 2 {θ}_{21}}{{w}_{21}} )}^{2} \}$$

$${P}_{22} ( 2 θ ) = {η}_{12} \frac{2}{π {w}_{22}} {\{ 1 + 4 {( \frac{2 θ - 2 {θ}_{22}}{{w}_{22}} )}^{2} \}}^{- 1} + ( 1 - {η}_{22} ) \frac{2}{{w}_{22}} {( \frac{ln 2}{π} )}^{1 / 2} exp \{ - 4 ln 2 {( \frac{2 θ - 2 {θ}_{22}}{{w}_{22}} )}^{2} \}$$

Here, η₁₁, η₁₂, η₂₁, and η₂₂ are constants indicating the proportions of Lorentzian components at P₁₁, P₁₂, P₂₁, and P₂₂, respectively, and each represent a number of 0 or more and 1 or less.

Also, 2θ₁₁, 2θ₁₂, 2θ₂₁, and 2θ₂₂ are positive constants indicating the peak top positions of P₁₁, P₁₂, P₂₁ and P₂₂, respectively.

Furthermore, w₁₁, w₁₂, w₂₁, and w₂₂ are positive constants indicating the peak widths of P₁₁, P₁₂, P₂₁, and P₂₂, respectively.

That is, free parameters used to derive P₁ and P₂ in the curve fitting are as follows.
I₁, η₁₁, η₁₂, θ₁₁, θ₁₂, w₁₁, w₁₂
I₂, η₂₁, η₂₂, θ₂₁, θ₂₂, w₂₁, w₂₂

However, from the viewpoint that diffraction lines derived from CuKα1 rays and CuKα2 rays for the same phase must have the same shape, the following constraints were set:
η₁₁=η₁₂, w₁₁=w₁₂, η₂₁=η₂₂, and w₂₁=w₂₂.

In addition, the following constraint was also set:
η₁₁, η₁₂, η₂₁, and η₂₂ are 0 or more and 1 or less.

Furthermore, the difference between the positions of diffraction lines derived from CuKα1 rays and CuKα2 rays in each of the first to third ranges is theoretically 0.06° or more and 0.08° or less, and thus the following constraints were also set to simplify the peak separation:

2θ₁₂=2θ₁₁+0.07; and

2θ₂₂=2θ₂₁+0.07.

The indication of validity of the minimum square root method was set to R<10.

The following angle difference Δ2θ between P₁ and P₂ can be obtained through the curve fitting:

Δ2θ=2θ₂₁−2θ₁₁.

### Lithium Ion Conductivity

Each of the solid electrolytes obtained in Examples and Comparative Examples was subjected to uniaxial press molding in a glove box purged with sufficiently dried Ar gas (with a dew point of −60° C. or less) by applying a load of about 6 t/cm². In this way, a sample for lithium ion conductivity measurement composed of a pellet with a diameter of 10 mm and a thickness of about 1 mm to 8 mm was produced. The lithium ion conductivity of the sample was measured using Solartron 1255B available from TOYO Corporation. The measurement was performed at a temperature of 25° C. and a frequency of 0.1 Hz to 1 MHz based on an alternating current impedance method.

TABLE 1

| | | | | First range | | | Second range | | | Third range | | | |
|---|---|---|---|---|---|---|---|---|---|---|---|---|---|
| | | Calcination conditions | | (25.6 ± 0.8°) | | | (30.2 ± 0.8°) | | | (31.6 ± 0.8°) | | | Lithium ion |
| | | | Temperature | θ₁₁ | θ₂₁ | Δ2θ | θ₁₁ | θ₂₁ | Δ2θ | θ₁₁ | θ₂₁ | Δ2θ | conductivity |
| | Composition | Atmosphere | (° C.) | (°) | (°) | (°) | (°) | (°) | (°) | (°) | (°) | (°) | (mS/cm) |
| Example 1 | Li_{5.6}PS_{4.4}Cl_{1.8} | Nitrogen | 600 | 25.58 | 25.68 | 0.10 | 30.09 | 30.23 | 0.14 | 31.48 | 31.60 | 0.12 | 5.1 |
| Example 2 | Li_{5.4}PS_{4.4}Cl_{1.6} | Nitrogen | 600 | 25.56 | 25.67 | 0.11 | 30.07 | 30.20 | 0.13 | 31.44 | 31.57 | 0.13 | 5.3 |
| Example 3 | Li_{5.6}PS_{4.8}Cl_{1.2} | Nitrogen | 600 | 25.58 | 25.64 | 0.06 | 30.09 | 30.19 | 0.10 | 31.46 | 31.56 | 0.10 | 4.5 |
| Comp. Ex. 1 | Li_{5.6}PS_{4.4}Cl_{1.8} | Nitrogen | 500 | 25.76 | 25.79 | 0.03 | 30.29 | 30.32 | 0.03 | 31.69 | 31.73 | 0.04 | 2.6 |
| Comp. Ex. 2 | Li_{5.4}PS_{4.4}Cl_{1.6} | Nitrogen | 500 | 25.69 | 25.69 | 0.00 | 30.21 | 30.22 | 0.01 | 31.60 | 31.60 | 0.00 | 3.3 |
| Comp. Ex. 3 | Li_{5.6}PS_{4.8}Cl_{1.2} | Nitrogen | 500 | 25.55 | 25.58 | 0.03 | 30.08 | 30.10 | 0.02 | 31.46 | 31.47 | 0.01 | 2.3 |

As is clear from the results shown in Table 1, in each of the solid electrolytes obtained in Examples, when each of the diffraction patterns in the first to third ranges in the XRD diffraction pattern was subjected to peak separation, two different peaks were observed. It can be seen from this that two different types of phases were present in each of the solid electrolytes obtained in Examples. It can also be seen that the solid electrolytes obtained in Examples in each of which two different types of phases were present exhibited higher lithium ion conductivity than the solid electrolytes obtained in Comparative Examples.

### INDUSTRIAL APPLICABILITY

According to the present invention, it is possible to provide a solid electrolyte that has ion conductivity higher than that of conventional solid electrolytes.

1. A solid electrolyte comprising:
a lithium (Li) element;
a phosphorus (P) element;
a sulfur (S) element; and
an X element, where X represents at least one halogen element,
wherein the solid electrolyte has a peak P₁ and a peak P₂ when, in an X-ray diffraction pattern obtained by measuring the solid electrolyte with an X-ray diffractometer (XRD) using CuKα1 rays and CuKα2 rays, a diffraction pattern in at least any one of a range of 28=25.6±0.8°, a range of 28=30.2±0.8°, and a range of 2θ=31.6±0.8° is subjected to peak separation, and
the peak P1 and the peak P2 are derived from different phases.

2. The solid electrolyte according to claim 1,
wherein the solid electrolyte has the peak P1 and the peak P2 when, in the X-ray diffraction pattern obtained by measuring the solid electrolyte with an X-ray diffractometer (XRD) using CuKα1 rays and CuKα2 rays, diffraction patterns in the ranges of 28=25.6±0.8°, 28=30.2±0.8°, and 28=31.6±0.8° are subjected to peak separation.

3. The solid electrolyte according to claim 1,
wherein the X element includes at least chlorine (Cl).

4. The solid electrolyte according to claim 1,
wherein the molar ratio (X/P) of the X element to the phosphorus (P) element is greater than 1.0.

5. The solid electrolyte according to claim 1,
wherein an angle difference Δ2θ between the peak P1 and the peak P2 is 0.04° or more.

6. The solid electrolyte according to claim 1,
wherein the solid electrolyte has a crystal phase of an argyrodite-type crystal structure.

7. A method for producing a solid electrolyte, comprising the steps of:
obtaining a raw material composition by mixing a lithium (Li) element source, a phosphorus (P) element source, a sulfur (S) element source, and a halogen (X) element source; and
calcining the raw material composition at a temperature of higher than 500° C. and lower than 700° C.

8. An electrode material mixture comprising:
the solid electrolyte according to claim 1; and
an active material.

9. A solid electrolyte layer comprising the solid electrolyte according to claim 1.

10. A battery comprising:
a positive electrode layer;
a negative electrode layer; and
a solid electrolyte layer provided between the positive electrode layer and the negative electrode layer,
wherein the battery contains the solid electrolyte according to claim 1.
